(19) United States
(12) Patent Application Publication
(10) Pub. No.: US 2026/0153645 A1
(43) Pub. Date: Jun. 4, 2026

(54) METHOD FOR BUILDING A RESERVOIR MODEL POPULATED WITH PETROPHYSICAL PARAMETERS

(71) Applicant: TotalEnergies OneTech, Courbevoie (FR)

(72) Inventors: Charles Danquigny, Pau (FR); Gérard Massonnat, Pau (FR); Déborah Siffert, Pau (FR); Cédric Gal, Pau (FR); Mickaël Barbier, Pau (FR)

(21) Appl. No.: 18/549,083

(22) PCT Filed: Jul. 28, 2023
(86) PCT No.: PCT/IB2023/000437

§ 371 Date: Sep. 5, 2023

(51) Int. Cl. G01V 20/00

(52) U.S. Cl. CPC G01V 20/00; G01V 2210/661

(57) ABSTRACT

A method for building a 3D model of a reservoir includes defining a pre-sedimentation model comprising a bottom surface comprising a plurality of cells, and iterating a plurality of deposition modelling steps, including simulating deposition of a layer of sediments on the bottom surface or a previously-deposited layer of sediment, each layer corresponding to a determined period of time of sedimentation and comprising a plurality of cells, and computing petrophysical parameters associated to at least a cell of the generated layer. Simulating deposition of a layer of sediments includes introducing a plurality of particles within the model, simulating transport of the particles comprising moving a particle from one cell to another or depositing the particle, and generating a layer comprising a plurality of cells, each cell associated to a thickness of deposited particles. The petrophysical parameters are computed from mineral elements and sizes of the particles deposited in each cell.

### BACKGROUND

### Technical Field

The present disclosure relates to a computer-implemented method for building a three-dimensional model of a geological reservoir, wherein this model is populated with petrophysical parameters. The disclosure finds notable applications in the field of Carbon Capture and Storage (CCS) and/or hydrocarbon production.

### Description of the Related Art

In the study of underground geological formations, it is necessary to have good knowledge of the distribution of the geological and petrophysical properties of the underground. These properties enable for instance to better determine the geometry of a geological formation, for instance an oil or gas reservoir, estimate the quantity and distribution of oil and gas resources, or the volume of carbon that could be stored in depleted oil and gas reservoirs, saline formations or the like.

In order to characterize a geological formation, it is well known to acquire on-site data for instance by campaigns or seismic reflections and/or by drilling exploration wells. This on-site data however only provide reduced hindsight about the distribution of geological and/or petrophysical properties over the whole domain of interest.

Accordingly, according to standard geostatistical approaches, it is known to build a structural model of a reservoir, comprising a set of geological surfaces comprising horizons, corresponding to iso-chronological surfaces that are determined from the on-site data, and faults, which are also observable on-site.

Based on the structural model, a three-dimensional mesh is then built which conforms to the horizons and faults, and which is then populated by geological and/or petrophysical parameters, according to geostatistical algorithms. The geostatistical algorithms enable filling the mesh from the sparsely acquired on-site data.

An important downside of populating a model with petrophysical parameters according to geostatistical computations is that the result is obtained without taking into account the complexity of geological phenomena having occurred successively during the formation of the reservoir. These phenomena can result in complex imbricated structures, leading to local heterogeneities that cannot be reflected by geostatistical approaches.

### BRIEF SUMMARY

An aim of the present disclosure is to improve the situation.

In particular, an aim of the present disclosure is to provide a method for building a three-dimensional model of a reservoir that is populated by petrophysical parameters with higher geological relevance, in view of more accurately estimating the properties of the reservoir for applications in CCS or hydrocarbon production.

Accordingly, described herein is a computer-implemented method for building a three-dimensional model of a reservoir, comprising:
defining a pre-sedimentation model comprising a bottom surface comprising a plurality of cells, and
iterating, a plurality of deposition modelling steps, including:
simulating deposition of a layer of sediments on the bottom surface or a previously deposited layer of sediment, each layer corresponding to a determined period of time of sedimentation and comprising a plurality of cells, and
computing petrophysical parameters associated to at least a cell of the generated layer,
   wherein simulating deposition of a layer of sediments comprises:
introducing a plurality of particles within the model, each particle being associated to a mineral element and a size,
simulating transport of the introduced particles, the transport of a particle comprising moving the particle from one cell to another or depositing the particle, and
generating, on the bottom surface or on a previously deposited layer of sediments, a layer comprising a plurality of cells where each cell is associated to a thickness of deposited particles, and
   wherein the petrophysical parameters associated to each cell of the generated layer are computed from the mineral elements and sizes of the particles deposited in each cell.

In embodiments, the petrophysical parameters associated to each cell comprise at least one porosity value and at least one permeability value.

In embodiments, the at least one permeability value associated to each cell comprises at least a horizontal permeability value and a vertical permeability value.

In embodiments, computing petrophysical parameters associated to a cell of the generated layer comprises computing an initial interparticular porosity and an initial interparticular permeability at the time of deposition.

In embodiments, computing petrophysical parameters associated to a cell of the generated layer comprises computing an initial interparticular porosity of a cell from a granulometric distribution of the deposited particles in the cell and a percentage of grains in the cell, wherein a grain is a particle having a size exceeding a determined threshold.

In embodiments, computing petrophysical parameters associated to a cell of the generated layer comprises computing an initial interparticular permeability from the initial interparticular porosity and a rock fabric of the cell, wherein the rock fabric is determined from the percentage of grains, the granulometric distribution and a sorting index of the particles deposited in the cell.

In embodiments, each deposition modelling step further comprises updating the petrophysical parameters of a cell of at least one previously deposited layer of sediments according to at least one post-deposition phenomenon.

In embodiments, the post-deposition phenomenon is compaction, and updating the petrophysical parameters of a cell is implemented based on a cumulative thicknesses of the layers of sediments located above the considered cell.

In embodiments, the method further comprises updating a thickness of a cell of a layer of sediments based on its updated petrophysical parameters.

In embodiments, defining the pre-sedimentation model further comprises defining a reference water level, a plurality of types of hydrozones, and a plurality of diagenetic phenomena, where each diagenetic phenomenon is associated to at least one type of hydrozone, and the method further comprises, for at least one cell of a deposited layer of sediments:
determining a type of hydrozone corresponding to the cell, based on an elevation of the cell and the reference water level,
inferring, from the type of hydrozone associated to the cell, at least one diagenetic phenomenon occurring in the cell, and
computing petrophysical parameters associated to the cell according to the at least one determined diagenetic phenomenon.

In embodiments, each cell is associated to a residence time in each of the plurality of types of hydrozones, the method further comprises, updating the residence time associated to the type of hydrozone corresponding to the cell, and computing the petrophysical parameters associated to a cell according to a determined diagenetic phenomenon is performed based on a cumulative residence time of the cell in all the types of hydrozones to which is associated the diagenetic phenomenon.

In embodiments, the at least one diagenetic phenomenon includes mineral stabilization, and computing petrophysical parameters associated to a cell due to mineral stabilization comprises computing a moldic porosity and a moldic permeability.

In embodiments, the at least one diagenetic phenomenon includes dissolution, and computing petrophysical parameters associated to a cell due to dissolution. comprises computing a vuggy porosity and a vuggy permeability

In embodiments, the at least one diagenetic phenomenon includes cementation, and computing petrophysical parameters associated to a cell due to cementation comprises computing at least an updated porosity value.

In embodiments, computing petrophysical parameters associated to the cell according to the at least one determined diagenetic phenomenon comprises updating an initial porosity value and an initial permeability value according to the at least one determined diagenetic phenomenon.

In embodiments, the method further comprises extracting, from the obtained model, a stratigraphic column comprising a superposition of a portion comprising at least one cell of each superposed layer in a determined area of the model, or computing, from the obtained model, at least one statistic distribution of at least one type of petrophysical parameter, for purposes of comparison with respectively a stratigraphic column or statistic distribution of a type petrophysical parameter obtained from on-site data acquisition.

According to another embodiment, a non-transitory computer readable storage medium is disclosed, having stored thereon a computer program comprising code instructions for implementing the method according to the description herein, when the computer program is executed by a processor of a computer.

According to another embodiment, a computer is disclosed that is configured for implementing the method according to the description herein.

The method allows forming a three-dimensional model of a reservoir by simulating a sedimentation process and computing petrophysical parameters that are an output of the sedimentation process. Moreover, the computed petrophysical parameters can take into account early diagenesis phenomena, known as eogenesis, said phenomena being localized and having strong impact on the petrophysical properties.

### BRIEF DESCRIPTION OF THE SEVERAL VIEWS OF THE DRAWINGS

The present disclosure is illustrated by way of example, and not by way of limitation, in the figures of the accompanying drawings, in which like reference numerals reference to similar elements and in which:

FIG. 1a is a flow chart describing the main steps of a possible embodiment of a method for building a three-dimensional model of a reservoir.

FIG. 1b is a flow chart describing the main steps of another possible embodiment of a method for building a three-dimensional model of a reservoir.

FIG. 2 is a diagram representing an example of definition of hydrozone and diagenetic zone types.

FIG. 3 is an exemplary texture classification.

FIG. 4 represents parameters for associating a cell to hydrozone or diagenetic zone types.

FIG. 5 is a possible embodiment of a device for implementing the method according to the disclosure.

### DETAILED DESCRIPTION

The method described below models the formation of a geological reservoir, by simulating the deposition over time of clastic and/or carbonates particles, thereby forming layers of sediments, and computing petrophysical parameters of the deposited sediments. The petrophysical parameters depend on the results of this sedimentation process, and also of additional processes such as early diagenetic phenomena occurring after sedimentation, known as eogenesis, or compaction.

With reference to FIG. 5, this method may be implemented by a device 10 comprises a computer, this computer comprising a memory 15 to store program instructions loadable into a circuit and adapted to cause circuit 14 to carry out the steps of the present disclosure when the program instructions are run by the circuit 14. The memory 15 may also store data and useful information for carrying the steps of the present disclosure as described above.

The circuit 14 may be for instance:
a processor or a processing unit adapted to interpret instructions in a computer language, the processor or the processing unit may comprise, may be associated with or be attached to a memory comprising the instructions, or
the association of a processor/processing unit and a memory, the processor or the processing unit adapted to interpret instructions in a computer language, the memory comprising said instructions, or
an electronic card wherein the steps of the disclosure are described within silicon, or
a programmable electronic chip such as a FPGA chip (for «Field-Programmable Gate Array»).

This computer comprises an input interface 13 for the reception of several data used for the above method according to the present disclosure, for instance an initial topography of a sedimentary deposition area, the parameters related to the production, supply or transport of particles, the parameters involved in the computation of petrophysical parameters, on-site data for comparison of the obtained model, etc. This computer also comprises an output interface 16 for outputting the reservoir model.

The computer may also include a display 11 for displaying a three-dimensional representation of the model, or any data derived therefrom, such as for instance a 2D representation of a stratigraphic column, etc.

To ease the interaction with the computer, the device may also comprise human input means such as a keyboard 12, mouse, and/or a tactile screen which are connected to the computer circuit 14. The various components described above may be remotely connected to one another, i.e., the memory storing the data and/or the circuit implementing the method may be remotely located with reference to the user and accessible through any suitable network.

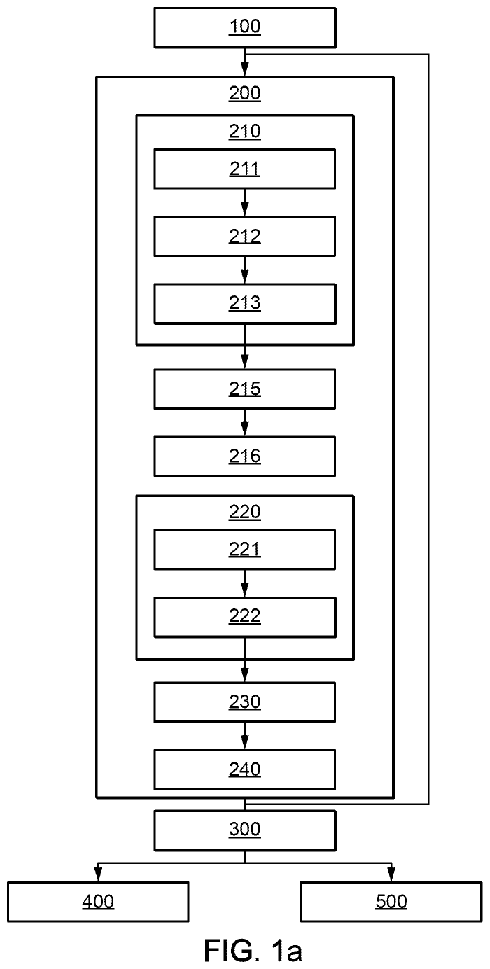

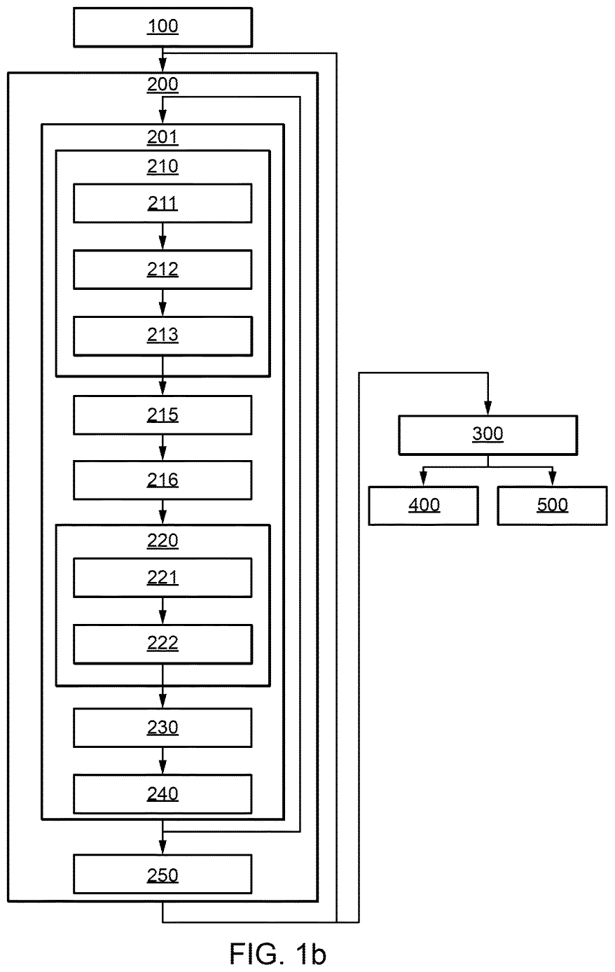

With reference to FIGS. 1a and 1b, embodiments of the main steps of the method will now be described.

The method comprises a first setup step 100, comprising defining a pre-sedimentation model comprising at least a bottom surface of determined topography, the surface comprising a plurality of cells defined by coordinates (x,y) and associated to initial elevation z₀ with respect to a reference plane. The bottom surface is further associated to an initial pre-sedimentation time tᵢₙᵢₜ. The bottom surface may be defined according to geological knowledge of a determined existing area comprising a geological reservoir. During step 100, the bottom surface may be recovered from a computer memory where it has been preliminary stored.

This bottom surface is the bottom of an immersed area which may be either marine, or lacustrine. Accordingly, the setup step 100 further comprises setting an initial reference water level zᵣ, and possibly an evolution of the reference water level over time. From the reference water level zᵣ and the initial elevation z₀ associated to each cell, a water depth WD is inferred and assigned to each cell. If the elevation z₀ of a cell is above the reference water level zᵣ, then the water depth is zero. It can be understood that as the method involves simulating the deposition of sediments, at least some of the cells of the bottom surface are below water level, i.e., z₀<zᵣ.

The setup step 100 may further comprise setting parameters enabling the simulation of deposition of a plurality of superposed layers of sediments on the bottom surface. In embodiments, this simulation is performed by forward stratigraphic modelling, and comprises, as explained in more details below, the introduction, within the model, of particles representing sediments, and the transport and deposition of the particles, depending on currents occurring on the particles, topography of the bottom surface or of the previously deposited layer of sediments, etc. Thus, the parameters enabling said simulation comprise at least:
parameters defining mineral type, granulometric distribution, location within the model, definition of production models of carbonate particles, supply models of siliciclastic particles, and
parameters enabling the computation of current and the simulation of transport of the introduced particles,
A skilled person may refer for instance to the patent applications WO2020/229863 or WO2020/229866 filed by the applicant, in particular the setup steps that are disclosed in these applications, as examples of steps for setting parameters of a forward modelling deposition tool.

In embodiments, when the method involves simulation of eogenetic phenomena, step 100 may further comprises defining a plurality of types of hydrozones, and a plurality of types of diagenetic phenomena, where each diagenetic phenomenon is associated to at least one type of hydrozone.

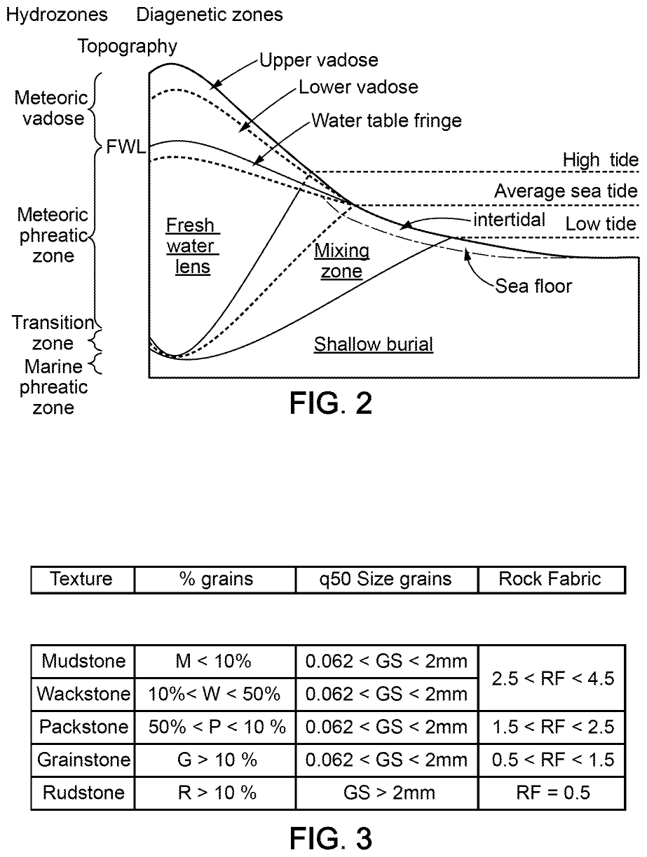

Hydrozones are zones of the ground that are distinguished based upon the fluid flows occurring within the zones. With reference to FIG. 2, the plurality of types of hydrozones may include at least:
a phreatic zone, or saturated zone, which is the part of the ground where the pores and fractures of the ground are saturated with water, and
a vadose zone, or unsaturated zone, which is the part of the ground between land surface and the top of the phreatic zone,

In embodiments, when the considered area is a marine area, the phreatic zone may further be decomposed into:
a marine phreatic zone, which is a zone saturated with sea water,
a meteoric phreatic zone, which is a zone saturated with fresh water derived from precipitations, including water from rivers, lakes, icemelts, etc., and
a transition zone, between the meteoric phreatic zone and the marine phreatic zone.

The different types of hydrozones may be determined according to following parameters applied to the cell of the model:
whether the cell belongs to an immerged or emerged zone, i.e., whether the cumulative elevation of the model at the cell is below or above the reference water level,
when tidal currents are simulated, the relative position of the cell, considering its cumulative elevation, with reference to the low tide and high tide levels,
the distance from the shore of a cell,
the position of the cell relative to a Free Water Level that is defined in more details below.

For instance, at the shore, the low tide sea level corresponds to the boundary between marine phreatic zone and transition zone.

In embodiments, in addition to defining a plurality of types of hydrozones, step 100 may further comprise defining a plurality of diagenetic zones, where each hydrozone comprises one or a plurality of different diagenetic zones, and each diagenetic phenomenon is associated to at least one type of diagenetic zone. This enables further refining geographical occurrence of diagenetic phenomena. When diagenetic zones are defined, these may be defined by a user or according to percentages of thickness of the hydrozone to which they belong.

According to non-limiting examples, a meteoric vadose zone may be decomposed into upper and lower vadose zones, corresponding to diagenetic zones. The transition between upper and lower vadose may correspond to a percentage of the thickness of the vadose zone.

A meteoric phreatic zone may be decomposed into water table fringe zone, and freshwater lens zone.

A transition zone may be decomposed into an intertidal zone, and a mixing zone, where the intertidal zone corresponds to a band of low depths cells located at the shore. The marine phreatic zone may be decomposed into a sea floor zone and a shallow burial zone, where the sea floor zone corresponds to a band of low depth cells extending from the shore at low tide level up to a determined distance thereof.

The definition of the hydrozones and diagenetic zones may be different when the considered area is a lacustrine area.

In embodiments, all types of hydrozones and diagenetic zones are pre-defined and step 100 may comprise, for a user, selecting a plurality of types of hydrozones and/or types of diagenetic zones that will be represented in the simulation.

The plurality of types of diagenetic phenomena may include at least one of the following phenomena:
Dissolution,
Cementation,
Mineral stabilization, and
Mineralogic transformation (e.g., dolomitization, thermal transformation, . . . ), etc.

Then, each diagenetic phenomenon is associated to at least one type of hydrozone, or, when defined, to at least one type of diagenetic zone. For instance, dissolution may be associated at least to vadose zone, or to the vadose zone and transition zone. By contrast, cementation may not occur in vadose zone and therefore may not be associated to said zone or any diagenetic zone within the vadose zone.

Furthermore, and as explained in more details below, when a diagenetic phenomenon is associated to a plurality of hydrozone types or diagenetic zone types, the parameters governing the simulation of said diagenetic phenomenon may vary from one type of hydrozone/diagenetic zone to another.

The method then comprises iterating a plurality of deposition modelling steps 200, where each deposition modelling step comprises:
simulating 210 deposition of a layer of sediments on the bottom surface or a previously deposited layer of sediments, where each layer corresponds to a determined period of time T, and comprises a plurality of cells, and
computing 220 petrophysical parameters of at least one cell of the deposited layer of sediments, and preferably of all the cells of the deposited layer of sediments.

In embodiments, each modelling step further may further comprise at least one of:
modelling 230 mechanical erosion on the cells located on top of the superposed layers of sediments and which are located above sea level, and
updating 240 parameters, including petrophysical parameters and/or thickness of a cell of at least one layer of sediment, and preferably all the cells of the previously deposited layers of sediments, to account for compaction occurring, on said previously deposited layers of sediments, due to the last deposited layer.

The output of each deposition modelling step 200 is therefore an updated version of the model, having one additional layer of sediments deposited over the period of time T, where said layer is populated with petrophysical parameters.

The duration of the period of time may be fixed or set by the user during the setup step 100. Preferably, this duration may be comprised between 1000 and 100.000 years, for instance between 1000 and 10000 years. Accordingly, each layer of deposited sediments corresponding to the period of time T may be called “time-layer” in the following.

In embodiments, and as shown in FIG. 1b, implementation of each step 200 may further be sub-divided into a plurality of iterated computation steps 201, where each computation step represents a period of time t inferior to the period of time T, in order to achieve higher precision in the simulation of the various processes. The period of time t represented by each computation step 201 may be comprised between 100 and 10.000 years, for instance between 100 years and a few thousands years. Furthermore, the number N of computation layers into which is subdivided each simulation step 200 may vary from one simulation step to the next. In order to increase a level of precision of the simulation to required areas, without involving too long computational time for areas for which an equal level of precision is not required.

When step 200 is subdivided into computation steps 201, then each computation step comprises implementation of steps 210, 220, and optionally 230, and 240 however computed for a shorter time period t_{comp}, and said computation steps are iterated until the sum of cumulative time periods t_{comp} equals the period of time T represented by a time layer.

In what follows, all steps will be considered for a so-called time step tₛ, which is defined as:
equal to the period of time t_{comp} when a modelling step is divided into computation steps 201, or
equal to the period of time T when the modelling step is not divided into computation steps.

Step 210 of simulating deposition of a layer of sediments is implemented by forward modeling. It comprises generating a layer having a plurality of cells (x,y), the definition of the cells preferably being the same as that of the bottom surface, where each cell is further associated to a time t_{s,i} which corresponds to a rank or iteration i of the time step tₛ, and can thus be associated to a geological time which is derivable from the rank of iteration and the period of time represented by the time step tₛ. Each cell is further associated to a thickness of deposited particles, which can be added to the elevation of the previously deposited layers of sediments at the same cell (x,y) to infer the elevation of that cell.

Accordingly, step 210 comprises at least:
introducing 211 a plurality of particles within the model, i.e., in at least one cell (x,y) of the model, where each particle is associated to a mineral element and a size,
simulating transport 212 of the introduced particles, where the transport of a particle comprises moving the particle from one cell to another, or depositing the particle on the ground, and
generating 213 the layer formed by the deposited particles, where each cell (x,y) of the generated layer has a thickness that is computed from the volume of deposited particles (where the volume is computed from the number and size of each deposited particles), divided by the area of the cell.

The number of particles introduced at step 211, as well as the location in which they are introduced, their mineral element and size, are determined from the supply and/or production models of particles that have been set initially during step 100 for the simulation. For instance, a user may have set a carbonates production model, defining:
a number of particles produced per time unit in each cell where production occurs,
a specific type of carbonates corresponding to the particles including for instance aragonite, low-magnesium calcite or high-magnesium calcite,
a granulometric distribution of the produced particles, and
the locations in which the particles are produced.

Simulating transport 212 of the introduced particles may comprise computing water currents occurring within the model and transporting the particles in accordance with the currents exerted on the particles, where transporting a particle implies either moving the particle from a cell to another, or depositing the particle.

For instance, the water currents occurring within the model can include one or more among: oceanic surface current, wind-induced current, tidal current, or river-mouth current.

Examples of detailed implementation of a step of computing water currents and simulating transport of particles, are provided in WO2020/229863 and WO2020/229866 mentioned above, and further in patent applications PCT/FR2022/051397 or PCT/FR2022/051398 also filed by the applicant.

Step 212 results, in each cell, in a number of particles of various sizes, and corresponding to various mineral elements being deposited, thereby leading to the generation 213 of a new layer of sediments associated with the iteration i.

The deposition modelling step 200 then comprises computing 220, for at least one cell of the deposited layer, i.e., of the layer corresponding to the current iteration i, petrophysical parameters associated to the cells.

Said petrophysical parameters may be derived from the number of deposited particles, the mineral element of each deposited particle and its size.

The computed petrophysical parameters may include at least one porosity value, and optionally at least one permeability value. Further, computing permeability values may include computing values of horizontal and/or vertical permeabilities.

The computation of petrophysical parameters may further include computing values of various types of porosity and/or permeability, including interparticular porosity/permeability, moldic porosity/permeability, and/or vuggy porosity/permeability.

In embodiments, step 220 comprises computing 221, for at least one cell of the last deposited layer, i.e., the layer deposited at step 210 of the same iteration of the computation step 201 or of the modelling step 200, an initial interparticular porosity, and optionally an initial interparticular permeability, at the time of the deposition. As can be seen in more details below, these initial values can then evolve according to phenomena occurring after deposition due to compaction and/or diagenetic phenomena.

The initial interparticular porosity of a cell may be computed from the granulometric distribution of the particles deposited in the cell, and a percentage of grains in the cell. In what follows, it is considered that particles having a size greater than a determined threshold correspond to grains, whereas particles having a size lower than said threshold correspond to mud. Thus, the percentage of grains is the percentage of particles, among all particles deposited in the cells, which size is higher than said threshold.

More specifically, the initial interparticular porosity Φ_{interpart,t}_{₀} associated to a cell during the same computation step as the deposition of the particles, may be computed according to the following equation:

$${Φ}_{intepart , {t}_{0}} = - 0 , 004 x + 0 , 8 + 0 , 005 * ln ( \frac{{q}_{84} - {q}_{16}}{4} + \frac{{q}_{95} - {q}_{5}}{6 , 6} ) - 0 , 0253$$

where x is the percentage of grains among the particles deposited in the cell, and qₓₓ is the xx^{th} quantile of the deposited elements size distribution.

An initial interparticular permeability may then be computed from the initial interparticular porosity and a rock fabric of the cell, where the rock fabric is a function of the percentage of grands, the granulometric distribution and a sorting index of the particles deposited in the cells.

The sorting index is an index representative of the degree of sorting of the deposited particles according to their size, and is also computed from the granulometric distribution, i.e., the distribution of the sizes of the particles deposited in the cell.

An example of expression of the sorting index z is:

$$z = index = \frac{{q}_{84} - {q}_{16}}{4} + \frac{{q}_{95} - {q}_{5}}{6 , 6}$$

The rock fabric may be computed as follows:

$$RF = ( - 0 , 0003 {x}^{2} - 0 , 0028 x + 3 , 9816 ) + ( - 0 , 072 ln ( y ) + 0 , 1361 ) + ( 0 , 1149 ln ( z ) + 0 , 5514 )$$

where x is, as above, the percentage of grains, and y is the q₅₀ particles size (in mm), i.e., the median size of the particles deposited in the cells.

The initial interparticular permeability K_{interpart,t}_{₀} may then be computed from the rock fabric RF and the initial interparticular porosity, from the following equation derived from Lucia, F. J., 2007, Carbonate Reservoir Characterization; An Integrated Approach (Second Edition), Springer Berlin Heidelberg, 336p.:

$$\begin{matrix}log ( {K}_{interpart , {t}_{0}} ) = 9 , 7982 - 12 , 0838 * log ( RF ) + ( 8 , 86711 - 8 , 2065 * log ( RF ) ) \\ * log ( {Φ}_{interpart , {t}_{0}} )\end{matrix}$$

In embodiments, step 221 also comprises determining a texture corresponding to the cells of the last deposited layer of sediments, where the texture is determined from:
the percentage of grains within the cell,
the rock fabric, and
the median size of the particles deposited in the cell.

The determination of the texture associated to a cell may be performed in accordance to the Dunham classification. FIG. 3 represents an example of texture classification according to determined ranges of the three parameters recited above.

In embodiments, step 221 also comprises computing an initial compaction coefficient Coef_{Comp,t}_{₀} associated to the cell of the last deposited layer of sediments. The compaction coefficient of a cell is a function of the percentage of grains, of cement, and elements sorting in the cell. It may be expressed as follows:

$${Coef}_{Comp} ( t ) = ( 4 x + 2200 ) * ( 1 + y ) * ( 1 + 0 , 106 ln ( z ) + 0 , 255 )$$

where x is the percentage of grains, y is the ratio

$$\frac{\% cement ( t )}{{Φ}_{interpart , {t}_{0}}}$$

and z is the sorting index introduced above. At the time of deposition, the percentage of cement in the cell is null, so

$${Coef}_{Comp , t 0} = ( 4 x + 2200 ) * ( 1 + 0 , 106 ln ( z ) + 0 , 255 ) .$$

In embodiments, the method may then comprise simulating diagenetic phenomena occurring in the cells of the last deposited layer, as well as to the cells of the previously deposited layers, and computing or updating 222 petrophysical parameters associated to the cells in accordance to said diagenetic phenomena.

In some embodiments, step 221 of computing initial interparticular porosity and permeability may be implemented before step 222, if these parameters are necessary for computing some petrophysical parameters due to some diagenetic processes.

In order to compute and update petrophysical parameters due to diagenetic phenomena, the deposition modelling step 200 (or computational step 201) comprises a step 215 of determining, for each cell of the model, i.e., each cell of the current layer of sediments as well as the previously deposited layers, a type of hydrozone to which belongs the cell.

This includes determining the areas of the model that are emerged, each emerged area being defined as a set of neighboring cells, where each cell of the set has an elevation exceeding the reference water level. When tide is simulated in step 210, the reference water level is the average sea level between high tide and low tide.

It also includes determining, for each emerged zone, an average permeability of the zone. The average permeability of the zone is computed from permeability values associated to the cells of the previously deposited layers of sediments corresponding to the emerged zone, i.e., all the cells of the previously deposited layers having coordinates (x,y) equal to the coordinates of the cells of the emerged zones, up to a maximum depth of for instance 40 meters.

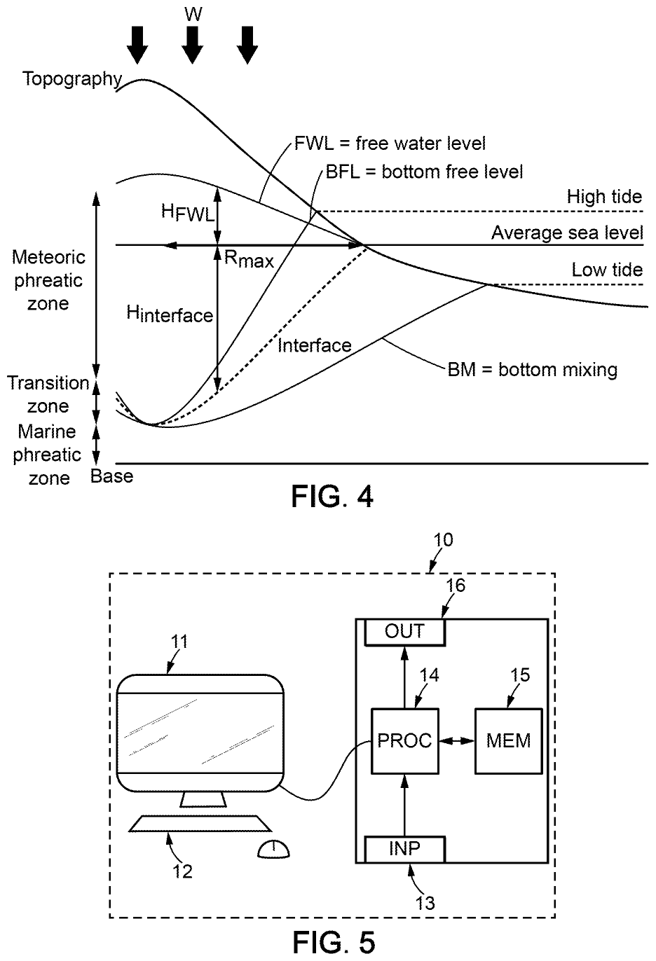

With reference to FIG. 4, determining a type of hydrozone to which belongs a cell may further comprise computing the location of the Free Water Level, which is the roof of the phreatic zone, and is only defined for emerged areas. The elevation, above sea level of the Free Water Level, is a function of the distance to the coast, a rainfall recharge and the average permeability of the emerged zone.

In embodiments, the Free Water Level may be computed as follows:

$${H}_{FWL} = \sqrt{\frac{0 , {31.1}^{- 2} \cdot w ( 2 {R}_{max} {r}_{coast} - {r}_{coast}^{2} )}{2 k ( 1 + δ )}}$$

where δ is a constant corresponding to a ratio between freshwater density, which is typically equal to 1000 and seawater density, typically equal to 1025, k (in mD) is the average permeability of the emerged zone, w (in mm/y) is the rainfall recharge per year that may be user-defined, H_{FWL} (in m) is the elevation of the FWL above sea level. Rmax is the maximum distance of the emerged area from the coast. It is computed by:
computing, from each cell of the emerged area, its minimum distance to the coast, by computing the minimum distance between the center of the considered cell to the center of an immersed cell, and
computing the maximum value over all the computed minimum distances.

Last, r_{coast} is the distance of a cell from the coast (considered as the distance between the minimum distance between the center of the cell and the center of an immersed cell).

In embodiments, when some hydrozone types are defined according to an intertidal zone, the location of an interface surface may be determined, which is located below sea level and represents the limit between freshwater and seawater. The elevation of this interface may be computed from the free water level as:

$${H}_{interface} = \partial * {H}_{FWL} = \frac{{d}_{f}}{{d}_{s} - {d}_{f}} * {H}_{FWL}$$

where d_{f} is freshwater density and dₛ is seawater density.

From said interface, the top limit and bottom limit of the intertidal zone may be defined, the top limit having an elevation, at the shore, corresponding to the high tide water level, and the bottom limit having an elevation, at the shore, corresponding to the low tide water level. The intertidal zone is defined until a location corresponding to the largest distance from the Shore where the top limit and bottom limit surfaces joint, with the interface surface.

Thus, the association of a hydrozone type to a cell may be performed the topography of the model resulting from step 210, and in particular from at least the following parameters:
the elevation of the cell, and
the reference water level.

Depending on the hydrozone type or diagenetic zone type, the following parameters may also be taken into account:
distance of the cell from the shore,
when immerged, a depth of the cell,
position relative to low tide or high-tide water level, or relative to surfaces delimiting two zones which are defined from said water levels,
position relative to Free Water Level.

According to a non-limiting example, back to FIG. 2, the association of a cell to a hydrozone type may be performed as follows:
meteoric vadose zone: corresponding to emerged cells located above Free Water Level,
meteoric phreatic zone: corresponding to cells located between Free Water Level and the top limit of the intertidal zone,
marine phreatic zone: corresponding to cells located below the bottom limit of the intertidal zone.

Further, when the transition zone is decomposed into a mixing zone and an intertidal zone, the association of a cell to one of said zones may be determined from the distance of the cell to the surface, as the intertidal zone is a band of cells of low depth.

When the marine phreatic zone is decomposed into a shallow burial zone and a sea floor zone, cells associated to the sea floor zone may be determined from their depth and from their distance to the shore at low tide.

Once a hydrozone type, or a diagenetic zone type has been assigned to each cell, the method comprises determining 216 a residence time of the cell in said hydrozone or, if diagenetic zones have been defined, in said diagenetic zone. The residence time of a given cell in a hydrozone type is the cumulative residence time that a cell has spent in said hydrozone type.

Therefore, for each cell, a residence time corresponding to each hydrozone type, or each diagenetic zone type is defined and stored, and, at each iteration of step 216, the residence time corresponding to the current hydrozone type associated to the cell is updated by adding the period of time corresponding either to the time layer or, as the case may be, to the computation layer.

Then, as each hydrozone type is associated to at least one diagenetic phenomenon, one can readily infer, from the hydrozone type associated to each cell, the diagenetic phenomenon or phenomena occurring in that cell.

Step 222 of computing petrophysical parameters due to diagenetic phenomena in a cell is thus performed according to the diagenetic phenomena occurring in that cell.

We will now describe the computation of the petrophysical parameters due to the various types of diagenetic phenomena.

A first type of diagenetic phenomenon occurring after deposition, and which may be simulated in the method, is mineral stabilization. Mineral stabilization concerns only limestone and consists in the early transformation of metastable phases such as high-Mg calcite and aragonite to stable low-Mg calcite. Therefore, mineral stabilization occurs in cells where particles corresponding to high-Mg calcite and aragonite are deposited (said types of mineral elements being among the elements corresponding to the introduced particles during the simulation of deposition of layers of sediments).

This chemical transformation is modelled as a dissolution of instable minerals formed by aragonite and high-Mg calcite, and precipitation of stable mineral, for instance low-Mg calcite.

The dissolution of instable minerals may be computed based on the initial cumulative proportion of instable minerals within the cell at the time of dissolution, and the cumulative residence time of the cell in hydrozones where mineral stabilization occurs:

$${M}_{i} ( ts ) = {M}_{i , {t}_{0}} . {e}^{- \frac{5}{{t}_{stab}} t}$$

where Mᵢ(tₛ) is the proportion of unstable minerals at timestep ts, t₀ is the time of deposition of the particles in the cell, t_{stab} is a fixed parameter corresponding to the time (in ky) where 100% stabilization occurs, i.e., when all the instable mineral is dissolved. This fixed parameter may be user defined. t is the cumulative residence time, i.e., it is the sum of the residence times of the cell in all hydrozones where mineral stabilization occur.

The precipitation of stable mineral is then a factor of the amount of dissolved unstable mineral, multiplied by an efficiency factor:

$${M}_{s} ( ts ) = {M}_{s , {t}_{0}} + \sum Eff \cdot ( {M}_{i , {t}_{0}} - {M}_{i} ( ts ) )$$

where Mₛ(st) is the proportion of stable minerals at timestep ts, the sum is implemented on all the types of instable elements, and Eff if the efficiency of the precipitation reaction for each element, which may be computed as a function of the rock fabric of the element, for instance:

$$Eff ( RF ) = \{ \begin{matrix}0 , 55 * {RF}^{0 , 4} , & RF < 4 , 5 \\ 1 , & RF \geq 4 , 5\end{matrix}$$

where RF is the rock fabric. Alternatively, the efficiency of the precipitation reaction may also be user-defined.

Dissolution of instable mineral that do not precipitate into stable mineral leads to apparition of moldic porosity, being a porosity created through the dissolution of the instable material but preserving the shape of the dissolved material.

The percentage of moldic grains, which become moldic porosity and not stable mineral element, at each timestep tₛ, may be computed as:

$${M}_{g} ( ts ) = {\sum }_{i} ( {M}_{i , {t}_{0}} - {M}_{i} ( ts ) ) * ( 1 - Eff )$$

and then the molding porosity calculation is provided as:

$${1}_{mold} ( ts ) = {Φ}_{mold , {t}_{0}} + {M}_{g} ( ts ) * ( 1 - {Φ}_{interpart , {t}_{0}} )$$

where Φ_{mold} (tₛ) is the moldic porosity at timestep ts, Mg(tₛ) is the proportion of moldic grains and Φ_{interpart,t}_{₀} is the initial interparticular porosity. For a first computation of a moldic porosity, Φ_{mold,t}_{₀}=0.

A moldic permeability may then be inferred from the moldic porosity by the following formula:

$${K}_{mold , t} = {10}^{3} \cdot {M}_{g} ( ts ) \cdot {Φ}_{mold} ( ts )$$

A second type of diagenetic phenomenon occurring after deposition, and which may be simulated in the method, is an early dissolution stage affecting carbonates. Dissolution is caused by rainwater which infiltrates into emerged zones. Therefore, dissolution may be associated to a meteoric vadose zone, and, if the meteoric vadose zone is further decomposed into diagenetic zones comprising an upper vadose zone and a lower vadose zone, dissolution may be associated to the upper vadose zone.

Dissolution generates touching vugs within the rock, and thus leads in the present method to creation of a vuggy porosity and a vuggy permeability which are computed and associated to a cell in which dissolution occurs.

The vuggy porosity may be computed as follows:

$${Φ}_{vuggy , postdissol} ( ts ) = {Φ}_{vuggy , predissol} ( ts ) + [ ( 1 - {Φ}_{tot , predissol} ( ts ) ) * {R}_{diss} ] * ts$$

where Φ_{vuggy,postdissol} (ts) is the vuggy porosity after simulating dissolution at timestep ts, Φ_{vuggy,predissol} (ts) is the vuggy porosity before simulation dissolution at the same timestep ts, ΣΦ_{tot,preddisol} (tₛ) is the sum of all types of porosities that have been computed in the cell before simulating dissolution at timestep tₛ, i.e., possibly of interparticular, vuggy and/or moldic porosities, and R_{diss} is a determined dissolution rate, which may preset or set by the user among the parameters initially defined for the simulation.

In embodiments, the dissolution rate R_{diss} may also depend on the location of the cell, in particular when a mixing zone is defined among the hydrozone types and dissolution is associated to the mixing zone. In that case the dissolution rate may exhibit a maximum, predefined value at shoreline and at the average sea level, and decreases with the distance from the shoreline, until reaching a value of 0 when the thickness of the mixing zone becomes 0. The decrease may be linear.

In order to compute permeability, it is considered that the dissolution process progressively increases the number of vugs, i.e., the density of vugs. Thus, a maximum vug size may be initially chosen by the user among a plurality of possible maximum sizes, and the vuggy permeability is computed from the vuggy permeability and parameters defined according to the maximum vug size, as follows:

$${K}_{vuggy , postdissol} ( ts ) = a * {Φ}_{vuggy , postdissol}^{b} ( ts )$$

where a and b have values that depend on the maximum vug size.

For instance, the user may select a maximum vug size among three possibilities: small, medium, and large, and the following values may be applied for each size:
Small: a=33; b=1
Medium: a=4.103; b=1.3
Large: a=5.105; b=1.6

A third type of diagenetic phenomenon occurring after deposition, and which may be simulated in the method, is cementation.

Cementation is a phenomenon concerning all lithologies. It may be associated to the following hydrozones or diagenetic zones: marine phreatic zone, intertidal transition zone, lower vadose. However, the cementation process differs according to the diagenetic zone in which it occurs. Therefore, as detailed below, the modelling of cementation is also different in accordance with the diagenetic zone type.

Cementation corresponds to the filling of porosity with cement, in different ways according to the type of porosity and the type of material. Thus, the modelling of cementation results in an updating previous porosity values.

When rock is considered as fully cemented, literature shows that there still remain some parts of the porous network without cement. Thus, a parameter of susceptibility to cementation SC is introduced, where the value of said parameter depends on:
the type of porosity that is considered (among interparticular, vuggy and moldic porosity), and
the type of rock that is considered, i.e., the texture associated to each cell.

Cementation in interparticular porosity is performed by updating a value of interparticular porosity, from the initial value of interparticular porosity that has been computed for the cell at step 221, as follows:

$${Φ}_{interpart} ( ts ) = ( SC * {Φ}_{interpart , {t}_{0}} ) {e}^{- λ {t}_{r}} + ( 1 - SC ) * {Φ}_{interpart , {t}_{0}}$$

where Φ_{interpart,t}_{₀} is the initial interparticular porosity computed at step 221, tᵣ is the cumulated residence time in the hydrozone or diagenetic zone in which cementation occurs at the time step ts, and λ is a decay constant of the porosity. A time Tc is also introduced corresponding to the time for achieving the cementation process, which is equal to:

$$Tc = 5 / λ$$

The value of Tc is predetermined, and, in embodiments, its value depends on the hydrozone type, or diagenetic zone type, in order to account for the variability of the cementation process according to the diagenetic zone where it occurs.

SC*Φ_{interpart,t}_{₀} is thus the part of the initial interparticular porosity that will decay and Φᵢₙₜₑᵣₚₐᵣₜ (ts) is the porosity that still remains and has not yet decayed after timestep ts.

Cementation in moldic or vuggy porosity is performed by updating a previous value of moldic, respectively vuggy porosity, and considering the cement already formed.

The updated value of moldic, respectively vuggy porosity, may be computed as follows:

$$\begin{matrix}{Φ}_{mold / vuggy , postcem} ( ts ) = [ SC * ( {Φ}_{mold / vuggy , precem} ( ts ) + {C}_{t - 1} ) ] {e}^{- λ {t}_{r}} + [ 1 - SC ) \\ * ( {Φ}_{mold / vuggy , precem} ( t ) s + {C}_{t - 1} ) ]\end{matrix}$$

where Φ_{mold/vuggy,postcem} (ts) is respectively the moldic or vuggy porosity after cementation at time step ts, Φ_{mold/vuggy,precem} (ts) is respectively the moldic or vuggy porosity before cementation, but within the same time step ts.

SC*(Φ_{mold/vuggy,precem} (t)+Cₜ₋₁)] is the moldic/vuggy-related volume that will have decayed at time Tc for achieving the cementation process, where Tc is still defined as:

$$Tc = 5 / λ .$$

Further, at each time step, a percentage of cementation %_{cement,ts} in the cell may be updated, starting from 0 at the first iteration, from the porosity update computed above.

In embodiments, when all the diagenetic phenomena disclosed above are modelled, step 220 is preferably implemented in the following order:
computation 221 of initial petrophysical parameters associated to the cells of the last deposited layer, then
simulation of mineral stabilization in cells of all deposited layers, according to the hydrozone types or diagenetic zone types in which mineral stabilization occurs, and creation/updating of moldic porosity, then
simulation of dissolution in cells of all deposited layers, according to the hydrozone types or diagenetic zone types in which dissolution occurs, and creation/updating of vuggy porosity, then
cementation, in cells of all deposited layers, according to the hydrozone types or diagenetic zone types in which cementation occurs, and updating of interparticular, moldic and vuggy porosities.

When the method comprises computation of different kinds of porosities and permeabilities, respectively, i.e., at least two of interparticular, vuggy, and moldic porosity (resp. permeability), the method may comprise recording in the memory each different kind or porosity (resp. permeability) separately. Moreover, a total porosity and a total permeability may be computed by summing respectively the different kinds of porosities and permeabilities. The total porosity and total permeability for each cell may also be recorded in the memory.

Back to FIGS. 1a and 1b, the method further may further comprise simulating 230 mechanical erosion of superficial emerged land.

Mechanical erosion affects all types of lithologies, and depends on several parameters including climate (in particular rainfall and runoff), elevation, slope and lithology. To simulate mechanical erosion, parameters of erodibility index EI and denudation intensity DI are introduced, where:
erodibility index EI is a parameter enabling to susceptibility to erosion of the lithology. Values, or ranges of values, of erodibility index may be assigned to various types of lithologies. For a given cell, determining the corresponding value of erodibility index may be based on the texture associated to the cell and, optionally, to the value of intergranular porosity at the considered time step that is associated to the cell.

Denudation Intensity DI is a parameter enabling to weight the rainfall impact on surface lowering. The denudation parameter may be selected by a user among a plurality of predefined values ranging from a minimum value to a maximum value.

Simulating erosion 230 comprises computing, for all the cells subject to erosion, i.e., all cells located in the last deposited layer of sediments (i.e., the layer deposited at the same time step) and which elevation is above sea level, of an amount of surface lowering with time Δe/Δt (in mm/ky), defined as follows:

$$Δ e / Δ t = ( 0 \text{.15} h ) ( w * DI ) * EI$$

where h (in m) is the elevation of the cell, and w (in mm/ky) is the rainfall recharge.

The thickness of each cell is then reduced of an amount of surface lowering Ae computed for the considered time step. If this amount exceeds the thickness of a cell, then the thickness of the cell located below is also reduced in order to reach a total thickness reduction equal to Δe.

In embodiments, the method may further comprise 240 computing, for at least a cell of any deposited layer of sediments, and for instance for all the cells of all deposited layers of sediments, updated petrophysical parameters due to compaction 240, which is itself due to the weight of the cumulative layers of sediments which are superposed above the considered cell.

The petrophysical parameters which are updated to account for compaction may be the total porosity and total permeability computed above. Alternatively or in complement, the petrophysical parameters updated according to compaction may be the different types of porosities and permeabilities computed above, i.e., interparticular, moldic and/or vuggy porosity, resp. permeability.

The porosity update due to compaction may be computed as follows, for instance for total porosity:

$${Φ}_{total , postcomp} ( ts ) = {Φ}_{total , precomp} ( ts ) . {e}^{- \frac{Th}{{Coef}_{Comp ( ts )}}}$$

where Φ_{total,postcomp} (ts) is the total porosity in a cell after compaction at timestep ts, Φ_{total,precomp} (ts) is the total porosity in a cell before compaction, i.e., after step 222 of the same timestep, and Th is the cumulated thickness of sediments above the considered cell.

The compaction coefficient Coef_{comp} (ts) of a cell has been introduced above and is updated at the end of each time step to take into account any increase in the percentage of cement.

This step 240 further comprises updating, in the same cells, the thickness of sediments due to compaction, where the updated thickness is computed from the initial thickness value of the considered layer of sediments and the updated porosity values, as follows:

$${h}_{comp} ( ts ) = {h}_{0} \cdot \frac{( 1 - {Φ}_{interpart , {t}_{0}} )}{( 1 - {Φ}_{total , postcomp} ( ts ) )}$$

where h_{comp} (ts) is the compacted deposit thickness for the considered time step ts, h₀ is the initial thickness of the deposit, Φ_{interpart,t}_{₀} is the initial interparticular porosity computed at step 221 right after deposition, and Φ_{total,postcomp} (ts) is the total porosity calculated after all eogenesis processes of the time step tₛ and updated due to compaction.

In embodiments, the method may also comprise computing a Net-to-Gross (NTG) value associated to each cell. This parameter represents a cutoff value defining a productive or non-productive zone of a reservoir for hydrocarbon exploitation.

This value may be defined as follows:

$$\begin{matrix}{NTG}_{ts} = 0 if \% grains < 50 \% \\ {NTG}_{ts} = 1 if \% grains > 50 \%\end{matrix}$$

This value does not vary with eodiagenesis or compaction and may thus be calculated at any moment after deposition of the particles.

With reference to FIG. 1b, when a deposition modelling step 200 is decomposed into a plurality of iteration of computational steps 201, the petrophysical parameters computed at each iteration of a computational step are preferably stored in order to keep a high resolution for these parameters.

However, the method may also comprise computing 250 equivalent values for the whole time-layer (i.e., for the whole period of time T, when each computation step 201 corresponding to a time step tₛ=t_{comp}) regarding a plurality of parameters, and storing said equivalent values, including at least one of the following:
the thickness of the cell,
one or a plurality of petrophysical parameters, or
the Net-to-Gross value associated to a cell.

The thickness of the cell, over the whole time layer, is computed as:

$${h}_{comp , cell} = \sum {h}_{comp , ts}$$

where h_{comp,cell} is the thickness of the cell after compaction and h_{comp,ts} is the thickness of the part of the cell corresponding to each time step ts included within T, after compaction.

The equivalent Net-to-Gross value for a cell may be computed from the NTG values of the part of the cell for the different time steps, and their respective thicknesses, as follows:

$${NTG}_{total , cell} = \frac{\sum {NTG}_{ts} * {h}_{comp , ts}}{{h}_{comp , cell}}$$

where NTG_{total,cell} is the equivalent NTG for a cell, NTGₜₛ is the NTG value of each part of the cell corresponding to a respective time step tₛ within T.

Regarding the equivalent petrophysical parameters, the method may comprise computing at least a total porosity of the cell, computed as follows:

$${Φ}_{total , cell} = \frac{\sum {Φ}_{total , ts} * {h}_{comp , ts}}{{h}_{c omp , cell}}$$

The method may also comprises computing a horizontal permeability K_{H,cell} and/or a vertical permeability K_{V,cell} of the cell, as follows:

$$\begin{matrix}{K}_{H , cell} = \frac{\sum {K}_{total , ts} * {h}_{comp , ts}}{{h}_{comp , cell}} \\ {K}_{V , cell} = \frac{{h}_{comp , cell}}{\sum {h}_{comp , ts} / {K}_{total , ts}}\end{matrix}$$

Equivalent petrophysical parameters may also be computed for the different types of porosity and permeability that have been computed above. For instance, if a vuggy porosity has been computed during the computational steps, an equivalent vuggy porosity for the whole time-layer may be computed from the vuggy porosities associated to each computation step.

After the plurality of iterations of step 200, the method may further comprise updating 300 the thicknesses and petrophysical parameters of all cells of all deposited layers of sediments, to account for post-sedimentary compaction. Indeed, the above-recited method enables simulating sedimentation having occurred on a defined area over a determined time frame, but said time frame may end well before the present day. This additional updating step 300 thus enables to account for additional sedimentation and compaction that are not within the scope of the simulation, but result in addition of a determined total thickness of additional sediments on the roof of the model. When the simulation aims at modelling the formation of a known reservoir for which on-site data are available, this total thickness of additional sediments may correspond to the thickness between ground surface and the top of the reservoir, possibly corrected to take into account erosion phenomena.

The final thickness of a cell of the model may thus be computed as:

$${h}_{final , cell} = {h}_{comp , cell} \cdot \frac{( 1 - {Φ}_{total , cell} )}{( 1 - {Φ}_{total , cell} \cdot {e}^{- \frac{{Depth}_{{MaxBurial}_{cell}} + {Depth}_{{cell}_{beforeBurial}}}{{Coef}_{Comp}}} )}$$

where Depth_{cell}_{_{beforeBurial}} is the depth of the cell at the end of the iterations of step 200, Depth_{MaxBurial}_{_{cell}} corresponds to the maximum depth of the cell after simulation, and corresponds to the depth of the cell at the end of the iterations of step 200 to which is added the additional thickness of sediments.

Last, the total porosity of a cell may also be updated due to this additional compaction, as follows:

$${Φ}_{final , cell} = {Φ}_{total , cell} . {e}^{- \frac{{h}_{final , cell}}{{Coef}_{Comp}}}$$

The obtained model thus comprises a plurality of layers of sediments, which formation has been driven by simulating physical phenomena, where each layer is decomposed into a plurality of cells and each cell is associated to petrophysical parameters which have been computed and updated to render a plurality of geological phenomena, including eodiagenesis phenomena and compaction. This model may therefore be readily used for comparison 400 to on-site data, for instance by extracting, from the model, a stratigraphic column comprising a superposition of a portion of each superposed layer comprising at least one cell of each layer, to be compared with a stratigraphic column obtained from on-site data acquisition campaign. Alternatively, statistic distribution of petrophysical parameters may be computed from the model and compared to a corresponding statistical distribution obtained from on-site data acquisition.

The comparison may enable, on the one hand, to correct the input parameters of the simulation and further refine the simulation, to obtain a model that more closely corresponds to observed data. On the other hand, when the model corresponds to observed data, it enables completing the knowledge of an actual reservoir, testing and selection exploitation hypothesis, for instance determining an amount of hydrocarbon that can be recovered from the reservoir or an amount of carbon dioxide that may be stored in the reservoir.

Further, the method may comprise a step 500 of displaying the obtained three-dimensional model on a screen, for a user visualization or analysis for instance. In that case, even if the implementation of a deposition modelling step 200 has been decomposed into a plurality of computational steps, only the time-layers, i.e., the layers of sediments corresponding to the period of time T and hence to the entire modelling step 200, may be displayed. The computational steps 201 are only for computational purposes and for computing high-resolution parameters but are not intended to represent actual, visible layers of sediments in the final model.

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A computer-implemented method for building a three-dimensional model of a reservoir, comprising:
defining a pre-sedimentation model comprising a bottom surface comprising a plurality of cells, and
iterating a plurality of deposition modelling steps, including:
simulating deposition of a layer of sediments on the bottom surface or a previously-deposited layer of sediment, each layer corresponding to a determined period of time of sedimentation and comprising a plurality of cells, and
computing petrophysical parameters associated to at least a cell of the generated layer,
wherein simulating deposition of a layer of sediments comprises:
introducing a plurality of particles within the model, each particle being associated to a mineral element and a size,
simulating transport of the introduced particles, the transport of a particle comprising moving the particle from one cell to another or depositing the particle, and
generating, on the bottom surface or on a previously-deposited layer of sediments, a layer comprising a plurality of cells where each cell is associated to a thickness of deposited particles, and
wherein the petrophysical parameters associated to each cell of the generated layer are computed from the mineral elements and sizes of the particles deposited in each cell.

2. The method according to claim 1, wherein the petrophysical parameters associated to each cell comprise at least one porosity value and at least one permeability value.

3. The method according to claim 2, wherein the at least one permeability value associated to each cell comprises at least a horizontal permeability value and a vertical permeability value.

4. The method according to claim 1, wherein computing petrophysical parameters associated to a cell of the generated layer comprises computing an initial interparticular porosity and an initial interparticular permeability at the time of deposition.

5. The method according to claim 1, wherein computing petrophysical parameters associated to a cell of the generated layer comprises computing an initial interparticular porosity of a cell from a granulometric distribution of the deposited particles in the cell and a percentage of grains in the cell, wherein a grain is a particle having a size exceeding a determined threshold.

6. The method according to claim 5, wherein computing petrophysical parameters associated to a cell of the generated layer comprises computing an initial interparticular permeability from the initial interparticular porosity and a rock fabric of the cell, wherein the rock fabric is determined from the percentage of grains, the granulometric distribution, and a sorting index of the particles deposited in the cell.

7. The method according to claim 1, wherein each deposition modelling step further comprises updating the petrophysical parameters of a cell of at least one previously-deposited layer of sediments according to at least one post-deposition phenomenon.

8. The method according to claim 7, wherein the post-deposition phenomenon is compaction, and updating the petrophysical parameters of a cell is implemented based on a cumulative thickness of the layers of sediments located above the considered cell.

9. The method according to claim 8, further comprising updating a thickness of a cell of a layer of sediments based on its updated petrophysical parameters.

10. The method according to claim 1, wherein defining the pre-sedimentation model further comprises defining a reference water level, a plurality of types of hydrozones, and a plurality of diagenetic phenomena, where each diagenetic phenomenon is associated to at least one type of hydrozone, and the method further comprises, for at least one cell of a deposited layer of sediments:
determining a type of hydrozone corresponding to the cell, based on an elevation of the cell and the reference water level,
inferring, from the type of hydrozone associated to the cell, at least one diagenetic phenomenon occurring in the cell, and
computing petrophysical parameters associated to the cell according to the at least one determined diagenetic phenomenon.

11. The method according to claim 10, wherein each cell is associated to a residence time in each of the plurality of types of hydrozones, the method further comprising updating the residence time associated to the type of hydrozone corresponding to the cell, wherein computing the petrophysical parameters associated to a cell according to a determined diagenetic phenomenon is performed based on a cumulative residence time of the cell in all of the types of hydrozones to which is associated the diagenetic phenomenon.

12. The method according to claim 10, wherein the at least one diagenetic phenomenon includes mineral stabilization, and computing petrophysical parameters associated to a cell due to mineral stabilization comprises computing a moldic porosity and a moldic permeability.

13. The method according to claim 10, wherein the at least one diagenetic phenomenon includes dissolution, and computing petrophysical parameters associated to a cell due to dissolution-comprises computing a vuggy porosity and a vuggy permeability.

14. The method according to claim 10, wherein the at least one diagenetic phenomenon includes cementation, and computing petrophysical parameters associated to a cell due to cementation comprises computing at least an updated porosity value.

15. The method according to claim 10, wherein computing petrophysical parameters associated to a cell of the generated layer comprises computing an initial interparticular porosity and an initial interparticular permeability at the time of deposition, and computing petrophysical parameters associated to the cell according to the at least one determined diagenetic phenomenon comprises updating an initial porosity value and an initial permeability value according to the at least one determined diagenetic phenomenon.

16. The method according to claim 1, further comprising extracting, from the obtained model, a stratigraphic column comprising a superposition of a portion comprising at least one cell of each superposed layer in a determined area of the model, or computing, from the obtained model, at least one statistic distribution of at least one type of petrophysical parameter, for purposes of comparison with respectively a stratigraphic column or statistic distribution of a type petrophysical parameter obtained from on-site data acquisition.

17. A non-transitory computer readable storage medium having stored thereon a computer program comprising code instructions, the computer program being loadable into a computer and adapted to cause the computer to carry out, when the computer program is run by a processor, the method according to claim 1.

18. A computer, configured for implementing the method according to claim 1.
